(19) United States
(12) Patent Application Publication
(10) Pub. No.: US 2007/0266841 A1
(43) Pub. Date: Nov. 22, 2007

(54) Circular Cutting Apparatus

(76) Inventors: Barbara Cotten Robinson, Louisville, KY (US); Jeffrey S. Robinson, Louisville, KY (US)

Correspondence Address: MIDDLETON & REUTLINGER, 2500 BROWN & WILLIAMSON TOWER, LOUISVILLE, KY, 40202, US

(21) Appl. No.: 11/749,199

(22) Filed: May 16, 2007

Related U.S. Application Data
(60) Provisional application No. 60/747,375, filed on May 16, 2006.

(51) Int. Cl. B23D 61/02; B27B 33/08

(52) U.S. Cl. 83/835; 83/663; 83/676

(57) ABSTRACT

The present invention provides a generally circular cutting blade suitable for use in conventional circular saws or equivalent power tools such as table saws and the like. The cutting blade of the present invention utilizes a pair of angled or concave portions or segments (as viewed from one side of the blade). A first portion is located at the radially outward periphery of the blade and a second portion is disposed radially inwardly therefrom. These first and second angled or concave portions are connected by a relatively flat blade portion that permits the radially outward portion to flex or deflect slightly from side to side as the blade is rotated through a work piece.

### CLAIM OF PRIORITY

This application under 35 USC §119(e) claims priority to, and benefit from, U.S. Provisional Application Ser. No. 60/747,375, filed on May 16, 2006, entitled “Circular Cutting Apparatus,” which is currently pending naming Barbara Cotten Robinson and Jeffrey S. Robinson as joint inventors.

### BACKGROUND OF THE INVENTION

1. Field of the Invention

The present invention relates generally to a circular cutting blade and more specifically to a circular saw blade suitable for use in conjunction with a wide variety of conventional circular power saws, such as a handheld circular saw or table saw. The invention facilitates the cutting of arcuate shapes in generally planar material while minimizing blade rubbing and binding against the material as well as minimizing sanding or filing of the remaining material edges once the cut has been completed.

2. Description of the Related Art

U.S. Pat. No. 4,602,434 to Stradling discloses a circular cutting device that provides a circular saw blade that is concave in cross-section that permits an operator to cut arcuate or circular holes in materials. The invention disclosed in the '434 patent provides for circular saw blades having differing degrees of concavity for cutting circles or arcs of differing diameters.

While useful, saw blades manufactured in accordance with the invention of the '434 patent often rub the sides of the material being cut. These saw blades rub on either side of the kerf as the blade rotates through the work piece. This rubbing is significant when attempting to cut material above, for example, one inch in depth due to the overall shape of the cutting blade. Consequently, the Stradling blade and those like it tend to heat up and bind when cutting holes of large or small radii in materials where a greater depth must be cut. As well as causing uneven or rough edges on the finished cut, this rubbing and binding is a significant source of blade wear and failure and is also dangerous to an operator as it can lead to the material being cut “kicking” or “jumping” as the blade binds against the material.

Additionally, prior art concave blades are incapable of making circular cuts in more than one direction since the overall concave shape of the blade forces the rotating saw blade either to the left or right through the material, depending upon the direction of the concavity and the directional arrangement of the cutting blade tips disposed on the periphery of the blade. This inherent limitation of prior art blades requires the manufacture of both a left hand and right hand cutting blade in order to cut right and left arcs in a surface, along with the necessity to either change out blades on the saw, or to have two saws available for circular cutting tasks at all times.

Accordingly, there is a need in the art for a circular saw blade that allows an operator to cut arcuate shapes of varying radii in desired material without the blade binding or rubbing as it rotates through the material. There is also a need for a circular saw blade that permits the cutting of both right and left arcuate shapes without the necessity of changing to a right or left-handed cutting blade. There is also a need for a circular saw blade that permits the cutting of material in arcuate shapes at a greater depth than that permitted by prior art arcuate blades.

### SUMMARY OF THE INVENTION

The present invention obviates the aforementioned problems by providing a generally circular cutting blade suitable for use in a conventional circular saws or equivalent power tools such as table saws and the like. The circular blade of the invention is readily secured to a conventional arbor shaft capable of rotation, as is the common mechanical method for securing a circular saw blade to a conventional circular saw.

The cutting blade of the present invention utilizes a pair of angled or concave portions or segments (as viewed from one side of the blade). A first portion is located at the radially outward periphery of the blade and a second portion is disposed radially inwardly therefrom. These first and second angled or concave portions are connected by a relatively flat blade portion that permits the radially outward surface to flex slightly from side to side as the blade is rotated through a work piece.

The invention further incorporates a plurality of conventional shaped blade cutting tips arranged around the perimeter of the blade, in order to facilitate the rotation of the blade through the material being cut. The cutting tips are designed to cut a kerf in the work piece that is sufficiently wide to enable the blade to rotate freely through the kerf, even as it is being turned by an operator to cut an arcuate shape.

When a blade in accordance with one embodiment of the present invention is placed flat on a surface, concave or angled portions up, the cutting tips of the blade are elevated from the flat surface, thereby providing the radially outward angled portion of the blade that terminates in a relatively flat central portion thereof that contacts or lies on the surface. The central portion is thence connected to a radially inward concave or angled portion that terminates in an arbor aperture for securing the blade to a saw.

Thus the present invention provides a circular cutting blade that permits an operator to cut right or left arcs in a planar material as the outer portion of the blade rotates through the material and flexes as the blade is directed in a leftward or rightward arc.

Other features and advantages of the present invention will be readily apparent from the detailed description of the preferred embodiments included herein below in conjunction with the drawing Figures.

### BRIEF DESCRIPTION OF THE DRAWING FIGURES

FIG. 1 is a side view of a cutting blade in accordance with one embodiment of the present invention.

FIG. 2 is a cross-sectional view of the cutting blade of FIG. 1 taken along the line 2-2 in accordance with one embodiment of the present invention.

FIG. 3 is an exaggerated scale cross sectional view of a cutting blade in accordance with one embodiment of the present invention.

FIG. 4 is an exaggerated scale cross sectional view of a cutting blade in accordance with one embodiment of the present invention.

FIG. 5 is an exaggerated scale cross-section view of a cutting blade in accordance with one embodiment of the present invention.

### DETAILED DESCRIPTION OF THE PREFERRED EMBODIMENT(S)

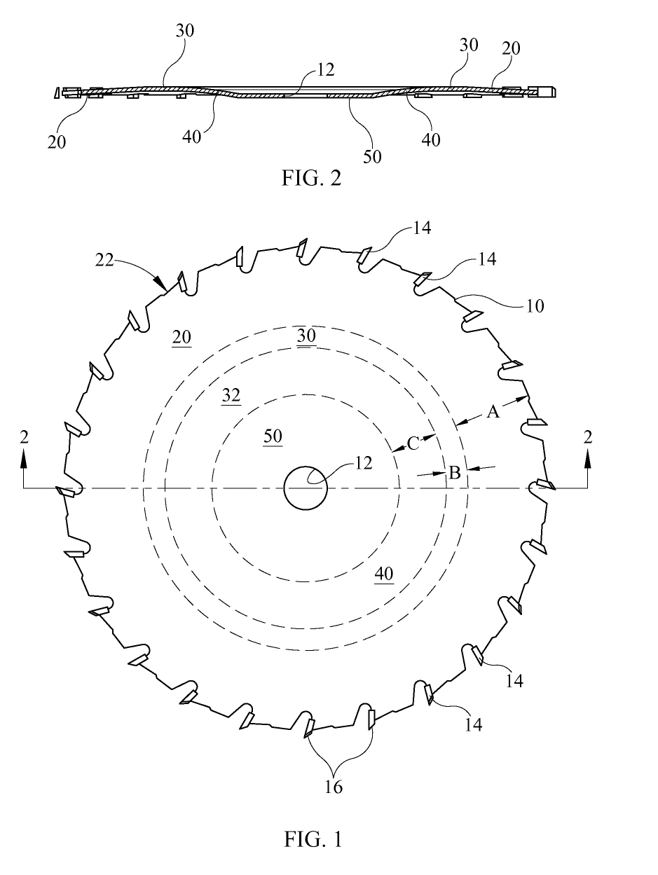

Referring now to FIGS. 1-5, and in accordance with a preferred constructed embodiment of the present invention, a generally circular cutting blade 10 suitable for use in a conventional circular saw or like power tool to cut arcuate kerfs therein comprises a central aperture 12 located at the center of blade 10 capable of receiving an arbor of a circular saw to secure the saw blade to an arbor shaft, which provides a means of rotation for the blade 10. Around the periphery of blade 10 there are arranged a plurality of spaced cutting teeth 14, each having a cutting tip 16 integrally secured to the leading edge thereof for removing material from a work piece as saw blade 10 rotates therethrough.

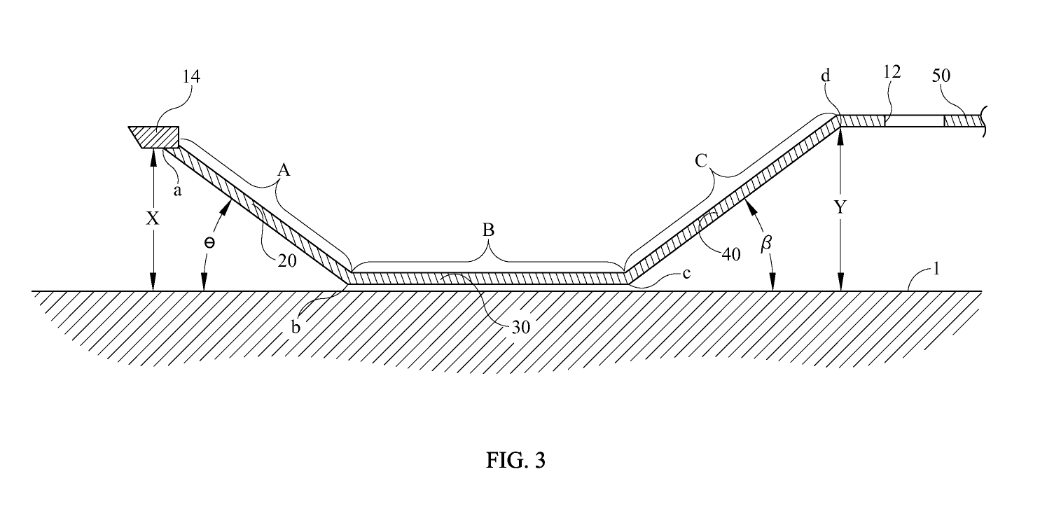

Referring now to FIG. 1 and to the cross-sectional view shown in FIG. 2, blade 10 comprises an outer concave or angled portion 20 that includes cutting teeth 14 spaced at regular intervals along a radially outer edge 22 thereof. FIG. 3 depicts an exaggerated scale cross-sectional view of blade 10 including geometric markings, wherein the shapes of the various portions of blade 10 are exaggerated for purposes of clarity, and wherein the concavity or angle of portion 20 is more readily seen.

Outer portion 20 terminates into and is connected to central portion 30, which is generally circular and disposed radially inwardly of outer portion 20 on blade 10. In one embodiment of the present invention, central portion 30 is generally flat across its diameter, denoted as dimension B in FIG. 3. Central portion 30 may be oriented to be substantially perpendicular to an axis running through central aperture 12. As best seen in FIG. 2, when blade 10 is laid flat against a generally planar surface 1, such as a table top, and is oriented such that cutting teeth 14 are not in contact with surface 1, central portion 30 is in contact with surface 1 along a substantial portion of its width B.

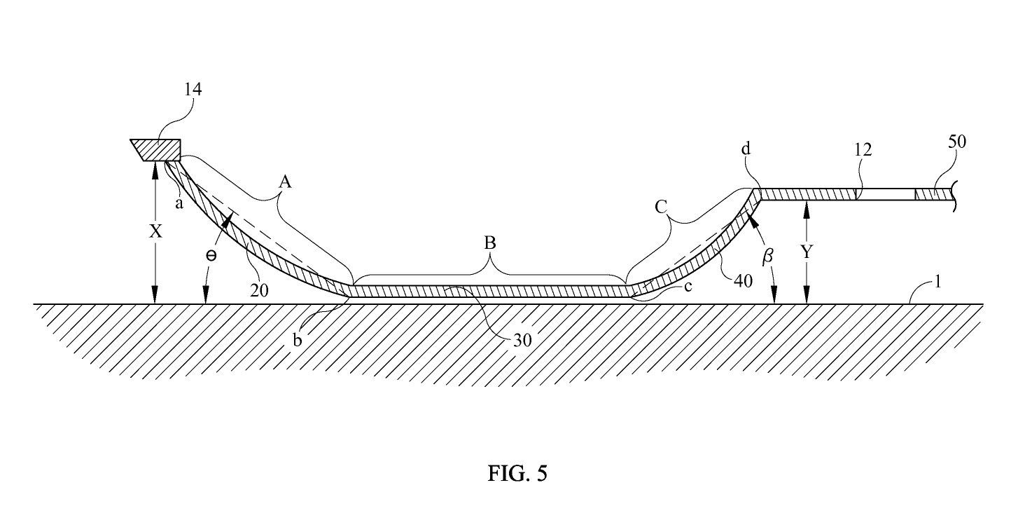

An inner concave or angled portion 40 is connected to a radially inward edge 32 of central portion 30 and extends radially inwardly towards central aperture 12. In one embodiment of the invention blade 10 includes a blade center section 50 that extends from a radially inward edge 42 of inner portion 40 inwardly towards central aperture 12. It is to be noted that outer portion 20 and inner portion 40 may be alternatively concave or relatively flat but oriented at an angle with respect to central portion 30 without departing from the scope of the present invention. In the embodiments of the invention wherein outer portion 20 and inner portion 40 are concave, a cross-sectional profile of portion 20 and portion 40 may be arcuate or parabolic, as best seen in FIGS. 2 and 5.

As can be seen from the foregoing description the improved cutting blade 10 of the present invention comprises at least three portions: an outer portion 20 that is radially located outermost from aperture 12 and is either concave in shape or oriented at an angle with respect to central portion 30, a central portion 30 that is disposed radially inwardly of outer portion 20, and an inner portion 40 that is disposed radially inwardly of central portion 30 and is either concave in shape or oriented at an angle with respect to central portion 30. The innermost portion of blade 10 may include center section 50, through which aperture 12 is disposed for affixing blade 10 to a saw.

As best seen in FIGS. 1-5, cutting tips 16 may have a width slightly wider than conventional tips to provide for enhanced kerf width. This feature of the present invention permits the outer and inner portions, 20 and 40, of the cutting blade to rotate through the kerf produced by the rotating blade relatively unimpeded, which reduces the binding and overheating common in conventional saw blades when cutting circular kerfs. It also facilitates the cutting of right or left arcuate shapes.

FIG. 3 depicts an exaggerated scale cross-sectional view of blade 10 in order to more accurately display the various shapes of the portions of blade 10 and their relationships to each other. As shown in FIG. 3, outer concave surface 20 extends from its radially outward point a to radially inward point b. Similarly, central portion 30 extends from its radially outward point b to its radially inward point c, and inner concave portion 40 extends from its radially outward point c to its radially inward point d. The line segment A denotes the hypotenuse of a triangle made by the vertical distance X between surface 1 and point a, line segment A, and the horizontal distance between points a and b along surface 1.

The line segment B simply denotes the length or width of central portion 30. The line segment C denotes the hypotenuse of a triangle made by the vertical distance Y between surface 1 and point d, line segment C, and the horizontal distance between points c and d along surface 1. The angle θ denotes the angle made by line A and surface 1. The angle β denotes the angle made by line C and surface 1.

In one embodiment of the present invention, blades 10 may be manufactured having an angle θ that may be in a range from about 11.9 degrees to about 2.75 degrees. Additionally, the angle β may be in a range from about 20 degrees to about 7 degrees.

In a yet further embodiment of the invention as seen in FIG. 3, the dimension X, which is the distance from the surface on which the blade is laid (or the distance from one side of the width of the blade) to the cutting teeth 14 is less than dimension Y, which is the distance from one side of the width of the blade to center section 50 through which aperture 12 is disposed. Stated another way, the vertical distance between the radially outermost point a of said outer section and said central section is less than the vertical distance between the radially innermost point d of said inner section and said central section.

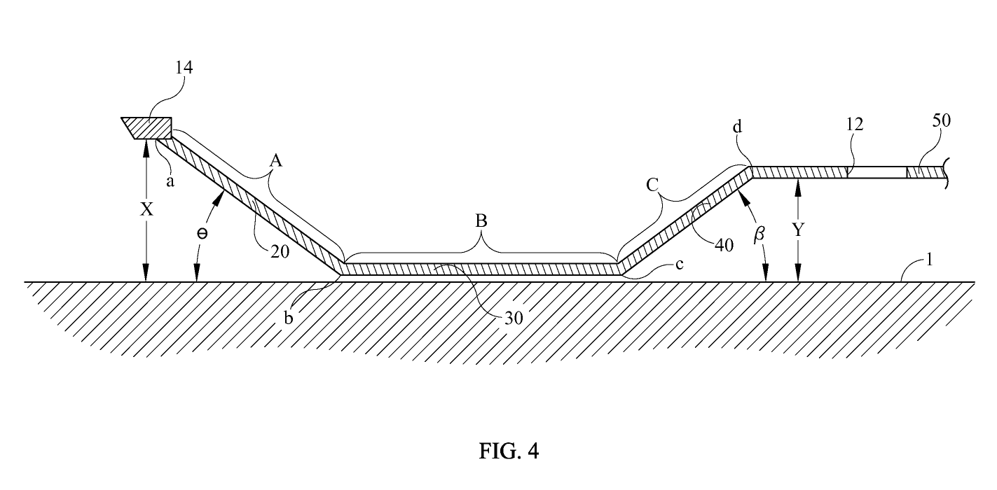

In another embodiment of the invention as seen in FIG. 4, the dimension X, which is the distance from the surface on which the blade is laid (or the distance from one side of the width of the blade) to the cutting teeth 14 is greater than dimension Y, which is the distance from one side of the width of the blade to the surface through which aperture 12 is disposed. In other words, in this embodiment of the invention the cutting teeth 14 are more elevated from surface 1 when blade 10 is laid thereon than center section 50 of blade 10 in which aperture 12 is disposed. Stated another way, the vertical distance between the radially outermost point a of said outer section and said central section is greater than the vertical distance between the radially innermost point d of said inner section and said central section.

FIG. 5 depicts a cross-sectional exaggerated scale view of a blade in accordance with another embodiment of the invention wherein outer portion 20 and inner portion 40 are both shown as concave in shape and connected by a relatively flat central portion 30.

In operation, as the power tool arbor shaft rotates at high speed, outer portion 20 readily cuts an arcuate kerf in the work piece, depending upon its degree and direction of concavity or its angle relative to central portion 30. Additionally, the arrangement of inner and outer concave portions 20 and 40 respectively, connected by flat portion 30, permits outer section 20 to cut away from the direction of concavity (or surface angle) so that blade 10 is capable of cutting left or right arcuate shapes in material without changing cutting directions or blades.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

We claim:

1. A circular saw blade for cutting arcuate shapes in generally planar material comprising:
an outer portion terminating in a radially outward edge; and
a central portion disposed radially inwardly of, and connected to said outer portion, said outer portion oriented at an angle relative to said central portion.

2. A circular saw blade as claimed in claim 1 further comprising:
an inner portion disposed radially inwardly of, and connected to said central portion, said inner portion oriented at an angle relative to said central portion.

3. A circular saw blade as claimed in claim 1 comprising:
a plurality of cutting teeth spaced around said radially outward edge.

4. A circular saw blade as claimed in claim 2 comprising:
a plurality of cutting teeth spaced around said radially outward edge.

5. A circular saw blade as claimed in claim 1 comprising:
a center section having an aperture therein for engaging an arbor shaft.

6. A circular saw blade as claimed in claim 2 comprising:
a center section disposed radially inwardly of, and connected to said inner portion, said center section having an aperture therein for engaging an arbor shaft.

7. A circular saw blade as claimed in claim 1 wherein the angle between said outer portion and said central portion is in a range from 2.75 to 16 degrees.

8. A circular saw blade as claimed in claim 2 wherein the angle between said inner portion and said central portion is in a range from 20 to 7 degrees.

9. A circular saw blade as claimed in claim 2 wherein the angle between said outer portion and said central portion is in a range from 2.75 to 16 degrees.

10. A circular saw blade as claimed in claim 2 wherein the angle between said outer portion and said central portion is about 5.6 degrees.

11. A circular saw blade as claimed in claim 10 wherein the angle between said inner portion and said central portion is about 9 degrees.

12. A circular saw blade as claimed in claim 2 wherein the vertical distance between the radially outermost point of said outer section and said central section is greater than the vertical distance between the radially innermost point of said inner section and said central section.

13. A circular saw blade as claimed in claim 2 wherein the vertical distance between the radially outermost point of said outer section and said central section is less than the vertical distance between the radially innermost point of said inner section and said central section.

14. A circular saw blade as claimed in claim 1 wherein said outer portion has a parabolic cross-sectional profile.

15. A circular saw blade as claimed in claim 2 wherein said inner portion has a parabolic cross-sectional profile.

16. A circular saw blade for cutting arcuate shapes in generally planar material comprising:
an outer concave portion terminating in a radially outward edge; and
a central portion disposed radially inwardly of, and connected to said outer concave portion.

17. A circular saw blade as claimed in claim 16 comprising:
a plurality of cutting teeth spaced around said radially outward edge.

18. A circular saw blade for cutting arcuate shapes in a generally planar material as claimed in claim 16 comprising:
an inner concave portion disposed radially inwardly of, and connected to said central portion.

19. A circular saw blade as claimed in claim 16 further comprising:
an center portion disposed radially inwardly of and connected to said inner concave portion, said center portion having an arbor aperture therein for securing said saw blade to a saw.

20. A circular saw blade as claimed in claim 16 wherein said central portion is substantially flat.

21. A circular saw blade as claimed in claim 16 wherein the angle between a line bisecting an outermost point of said outer concave portion and an outermost point of said central portion and a line parallel to said central portion of said blade is in a range between 2.75 to 16 degrees.

22. A circular saw blade as claimed in claim 18 wherein the angle between a line bisecting an outermost point of said inner concave portion and an outermost point of said central portion and a line parallel to said central portion of said blade is in a range between 20 to 7 degrees.

23. A circular saw blade as claimed in claim 16 wherein said outer concave portion has a parabolic cross-sectional profile.

24. A circular saw blade as claimed in claim 18 wherein said inner concave portion has a parabolic cross-sectional profile.
